(19) United States
(12) Patent Application Publication
(10) Pub. No.: US 2025/0211984 A1
(43) Pub. Date: Jun. 26, 2025

(54) HANDOVER CONNECTIVITY AND PRIVACY FOR COMMUNICATION SYSTEMS

(71) Applicant: Intel Corporation, Santa Clara, CA (US)

(72) Inventors: Barath C. Petit, Bangalore (IN); Navya P, Bengaluru (IN); Chandrashekar Devegowda, Bangalore (IN); Amit Singh Chandel, Bangalore (IN); Naveen Manohar, Bangalore (IN); ASHWINI RATHI, Tiki (IN); Suranjan Chakraborty, Bangalore (IN); Sheetal Bhasin, Bangalore (IN); Jayprakash Thakur, Bangalore (IN); Ruchi Padekar, Ahmednagar (IN); Vineet Kumar, meerut (IN); Arun Loni, BUAPUR (IN); Harish Mitty, Bangalore (IN)

(21) Appl. No.: 18/395,138

(22) Filed: Dec. 22, 2023

(51) Int. Cl. H04W 12/06; H04B 17/318; H04L 9/40; H04W 56/00

(52) U.S. Cl. CPC H04W 12/06; H04B 17/328; H04L 63/0861; H04W 56/0015

(57) ABSTRACT

Control devices for network control and privacy protection are described. For network control, processing circuitry can exchange information with at least one other device to determine which device should communicate to a peripheral device. The processing circuitry can pass a token to the at least one other device in response to detecting the at least one other device should communicate to the peripheral device, and refrain from further transmissions after passing the token. In privacy control, users can be notified before audio is played on a new or different peripheral device.

### TECHNICAL FIELD

Aspects of the disclosure pertain to communication systems. More particularly, aspects relate to improving device handover for seamless connectivity and in consideration of privacy concerns.

### BACKGROUND

Device users often face issues of limited range when using some types of communication protocols and frequency ranges. Privacy can also be a concern particularly when user devices connect automatically to sound or audio systems.

### BRIEF DESCRIPTION OF THE DRAWINGS

In the drawings, which are not necessarily drawn to scale, like numerals may describe similar components in different views. Like numerals having different letter suffixes may represent different instances of similar components. Some aspects are illustrated by way of example, and not limitation, in the figures of the accompanying drawings in which:

FIG. 1 illustrates a network in which some methods can be implemented according to aspects of the disclosure.

FIG. 2 illustrates epochs of protocol operation according to aspects of the disclosure.

FIG. 3 illustrates an application of Bluetooth handover according to aspects of the disclosure.

FIG. 4 illustrates application of Bluetooth piconet synchronization to the multi-point Bluetooth problem according to aspects of the disclosure.

FIG. 5 illustrates an application in which multiple peripherals are abstracted as a single peripheral to a roaming BT central device according to aspects of the disclosure.

FIG. 6 is a flowchart of a method for device authentication upon device pairing according to aspects of the disclosure.

FIG. 7 is a visual representation of a database having user profiles according to aspects of the disclosure.

FIG. 8 is a flowchart of a method for protecting user privacy in Bluetooth device use according to aspects of the disclosure.

FIG. 9 illustrates a block diagram of a communication device such as an evolved Node-B (eNB), a new generation Node-B (gNB), an access point (AP), a wireless station (STA), a mobile station (MS), or a user equipment (UE), in accordance with some aspects.

FIG. 10 illustrates a system level diagram, depicting an example of an electronic device (e.g., system) that can include, for example, a transmitter configured to selectively fan out a signal to one of multiple communication channels.

### DETAILED DESCRIPTION

The following description and the drawings sufficiently illustrate specific aspects to enable those skilled in the art to practice them. Other aspects may incorporate structural, logical, electrical, process, and other changes. Portions and features of some aspects may be included in, or substituted for, those of other aspects. Aspects set forth in the claims encompass all available equivalents of those claims.

Bluetooth (BT) users often face the issue of limited range e.g., audio streaming or voice call whereby the device connection degrades if a user moves out of range. A power-efficient multi-point Bluetooth (single BT peripheral communicating with multiple BT central devices) implementation with minimal switchover latency would address these concerns.

Privacy is also a concern when there are multiple possible audio devices or other devices that could stream audio or visual content of the user. For example, if a user is moving out of range of one device, a privacy concern could arise if his or her audio content started streaming unexpectedly on another device. Privacy prompts or other authorization methods could address these concerns.

### Seamless BT Connectivity

Bluetooth users often face the issue of limited range e.g., audio streaming or voice call whereby user connectivity (UX) degrades if a user moves out of range. Certain Bluetooth peripherals in the market are enabled with native multi-point Bluetooth support. However, these multi-point BT peripherals have a maximum limit for connected BT devices. For example, most available BT peripherals are limited to two connections due to processing and power limitations at the BT peripheral.

Furthermore, devices supporting native multi-point Bluetooth do not offer a seamless switching experience. Often the UX is not ideal with significant switchover time in the order of few minutes. There are handover procedures that are available for Wi-Fi and cellular communications but these cannot be applied to Bluetooth piconet topology.

To address these and other challenges, methods, and systems according to aspects of this disclosure provide a Bluetooth piconet synchronization scheme whereby multiple Bluetooth central devices are synchronized and are abstracted as a single Bluetooth device to the Bluetooth peripheral. Synchronization is done in a manner agnostic to the BT peripheral/s. No hardware or software changes need to be implemented at the BT peripheral/s.

Bluetooth piconet synchronization can be leveraged by systems and methods to address limited Bluetooth range. As can particularly occur in audio use cases, Bluetooth users experience a marked degradation and eventual disconnection as they move out of range. To combat this, multiple devices (e.g., personal computers (PCs), laptops, etc.) can be deployed to provide a seamless BT UX for the end-user. A Bluetooth soft handover mechanism can be provided as described in more detail later herein.

Bluetooth piconet synchronization can also be leveraged by multi-point Bluetooth systems. Multi-point Bluetooth arises from the requirement for the Bluetooth peripheral (headset, mouse etc.) to interact with more than one Bluetooth central device during its normal operation. For example, a BT headset (equivalently the user) may need to interact with a laptop/PC and a smartphone based on context in a single session. In this and similar use cases, the BT peripheral may need to seamlessly switch between the phone and PC/laptop. The proposed Bluetooth handover solution can be deployed in the multi-point Bluetooth context scenarios described above.

In the context of aspects described below, a BT central can be understood to be an initiator that sends connect requests to the peripheral and typically corresponds to laptop, PCs, smartphones, tablets etc. A BT peripheral is a device that accepts the connection and typically corresponds to Bluetooth peripherals like headset, mouse, keyboard etc. In some systems, a BT peripheral can become or be activated as a BT central. A BT Piconet can be understood as a Bluetooth network unit linking the BT central and its connected BT peripheral devices. The BT piconet operates on a clock and frequency hop sequence (FHS) set by the BT central. A channel hop sequence can also be defined and implemented.

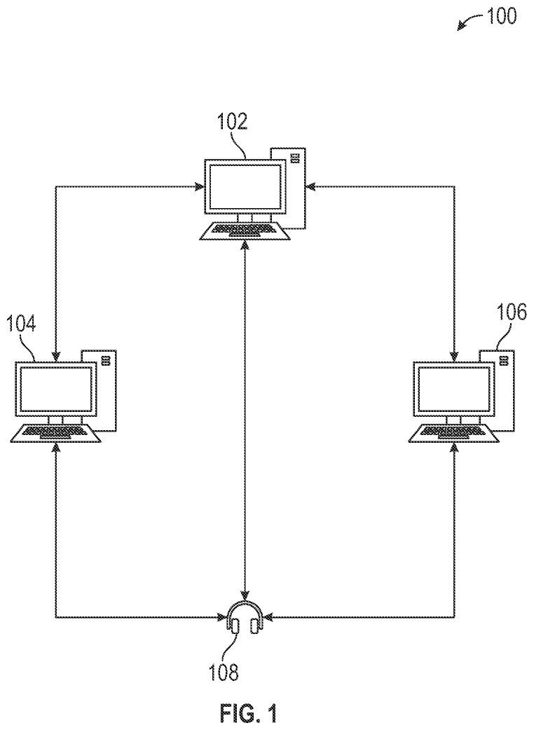

FIG. 1 illustrates a network 100 in which some methods can be implemented according to aspects of the disclosure. In a typical BT piconet operation, the topology can be as shown in FIG. 1. As seen in FIG. 1, a network 100 (hereinafter piconet) topology includes one active BT central 102, other candidate BT centrals 104, 106, and at least one peripheral 108. and more than one BT peripheral. As part of the proposed BT handover solution, the participating candidate BT central devices 104, 106 shall be in synchronization with the BT piconet clock and allied parameters.

The BT piconet 100 can have only one active BT central 102 at any given time. The currently active central device is referred to as Primary BT central 102. The rest of the participating BT central devices 104, 106 re referred to as Secondary BT centrals. Only the primary BT central 102 has transmit (Tx) and receive (Rx) permissions. The secondary BT central devices 104, 106 have only Rx permissions meaning they can listen to the piconet traffic but cannot participate actively. Primary and secondary BT central devices 102, 104, 106 together would be referred by the term participant BT central devices. Thus, both the primary and secondary BT central devices shall be synchronized with respect to the BT piconet parameters. In at least this sense, BT piconet synchronization amongst the primary and secondary BT central devices is one primary building block for soft handover and other methods according to aspects of this disclosure.

The participant BT central devices 102, 104, 106 come together as a whole to appear as (e.g., be abstracted as) a single BT central device to the BT peripheral device 108 with a single MAC address. During the operation of the BT handover algorithm, the role of the primary BT central 102 is switched and assigned to another BT central device 104, 106 as needed. Because all the participant BT central devices 102, 104, 106 are tuned to the BT piconet 100, all the BT central devices 102, 104, 106 can receive transmissions from the BT peripheral 108 (if they are within range) and measure the BT signal strength (e.g., received signal strength indicator (RSSI)) and related link parameters. However, only the primary BT central device 102 will have Tx permissions and maintains the link while the secondary BT central devices 104, 106 continue to listen passively.

The participant BT central devices 102, 104, 106 shall communicate via a protocol, described later herein, to periodically synchronize on the BT piconet 100 parameters. The participant BT central devices 102, 104, 106 shall exchange signal strength information, BT link state information with respect to the BT peripheral 108 so that a new primary BT central can be assigned if needed. The communication protocol for aspects of this disclosure can operate on a PHY which is orthogonal to BT 2.4 GHz (e.g., the protocol can over operate over Wi-Fi 5/6 GHz or Ethernet.

The primary BT central device 102 can hold or maintain a BT piconet 100 token that allows it to both Tx and Rx. The remaining secondary BT central devices 104, 106 have only Rx permissions. If a switch is to be made as per the aforementioned protocol, the token is passed to the newly assigned primary BT central device at which point the previous primary BT central device becomes a secondary BT central device (and only has Rx permissions, until and unless another handover is made).

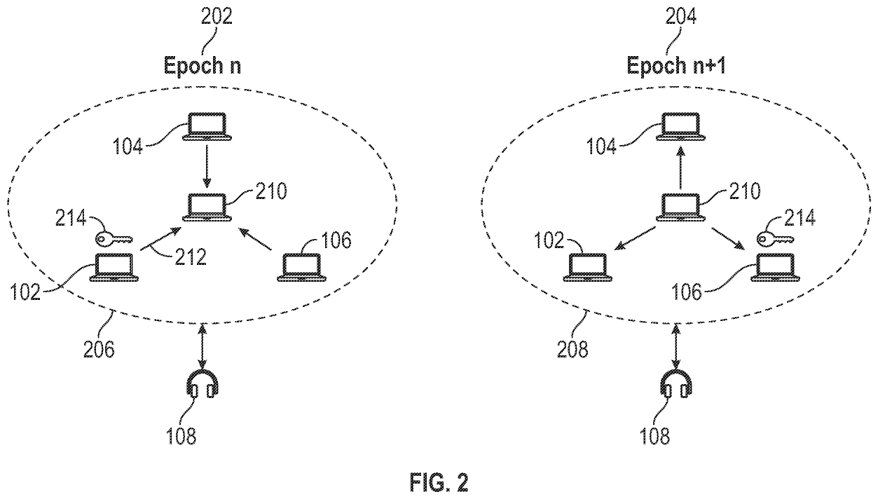

The protocol operates in a two-phase manner and timeline is divided into distinct epochs as shown in FIG. 2. Each epoch 202, 204 is divided into two phases including a message exchange phase 206 and a token assignment phase 208. In the message exchange phase 206, participant BT central devices 102, 104, 106 can exchange their respective BT RSSI and link information with respect to the BT peripheral device 108. To optimize the latency of the protocol, a leader node 210 can be assigned from the set of participant BT centrals 102, 104, 106, but leader node 210 is separately labeled in FIG. 2 for purposes of clarity. All the participant BT centrals 102, 104, 106 can send their link information to the leader: 210. The leader 210 can execute an inference algorithm to choose the primary BT central for the next epoch 204 based on link state data receive from the participating nodes. The current primary BT central can also provide updated piconet 100 synchronization information message 212.

In the token assignment phase 208, the leader 210 can inform the participant BT centrals 102, 104, 106 as to which of the participant BT centrals 102, 104, 106 shall receive the recipient of the token 214, which comes into effect from the next epoch 204 onwards. The leader 210 can also transmit piconet 100 synchronization information received from the currently active BT central in the previous (message) phase 206 (BT central 102 in the illustrated example).

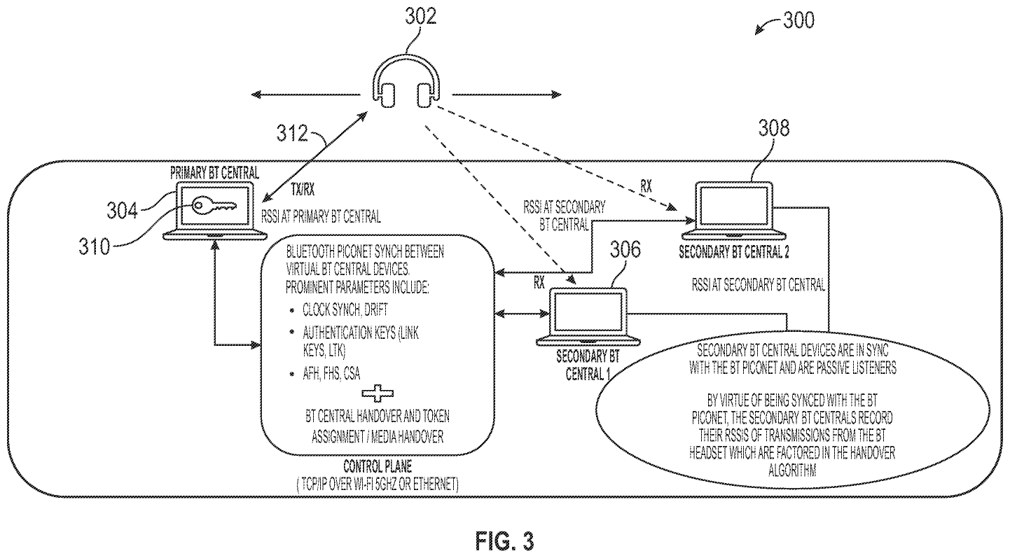

FIG. 3 illustrates an application 300 of Bluetooth handover in accordance with aspects of this disclosure. The application 300 can be used to provide extended range for Bluetooth audio use cases. The protocol implementations described with respect to FIG. 1 and FIG. 2 can be provided on various personal computers, etc., in a home or corporate environment without changes to BT peripheral hardware or software. can be installed in additional Intel PCs and can be deployed in both the personal/home and corporate/enterprise environment.

Referring to FIG. 3, as a BT peripheral 302 moves, a BT central device 304, 306, 308 that is nearest to the peripheral 302 is assigned the token 310 and becomes the primary BT central. The primary BT central has Tx and Rx permissions as shown in communication link 312. The token 308 is assigned by the handover algorithm described above with respect to FIG. 2, to the BT central 304, 306, 308 having the best RSSI with respect to the BT peripheral 302.

A BT piconet synchronization is maintained between BT central 304, 306, 308. Parameters can include clock synchronization, drift information, authentication keys (e.g., link keys, long term keys (LTK), etc.), adaptive frequency hopping (AFH) information, FHS, channel selection algorithms (CSA), etc. Control plane can be TCP/IP over WiFi (e.g., 5 GHZ) or Ethernet, by way of example.

Secondary BT centrals 306, 308 shall be synchronized with the BT piconet as passive listeners. By virtue of being synchronized with the BT piconet, the secondary BT centrals 306, 308 can detect RSSI of transmissions from the BT peripheral 302, which are factored into the handover algorithm.

As discussed earlier, multi-point Bluetooth arises from the requirement of a Bluetooth peripheral to communicate with two or more Bluetooth central devices. Here roaming is not key, and the solution is relevant even when the user is stationary.

The solution can easily scale to multiple BT centrals connected to the BT peripheral via the virtual abstracted link (piconet synchronization). Moreover, as no power overhead is incurred on the BT peripheral because the BT peripheral aware only of the primary BT central. The secondary BT centrals share a virtual BT connection with the BT peripheral by virtue of the Bluetooth piconet synchronization.

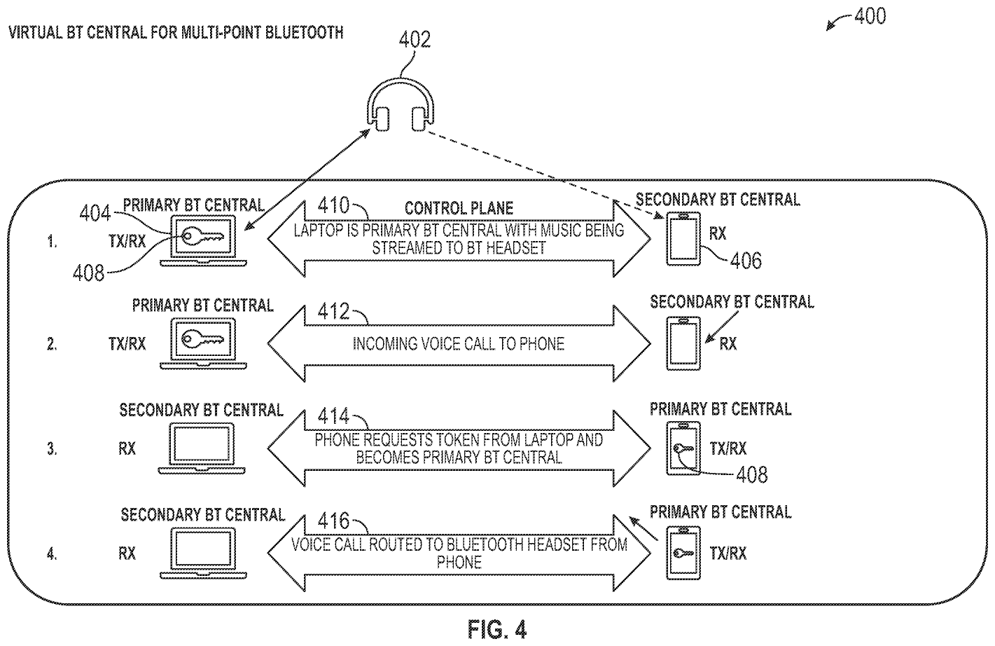

FIG. 4 illustrates application 400 of Bluetooth piconet synchronization to the multi-point Bluetooth problem in accordance with some aspects of the disclosure. A BT peripheral 402 can be simultaneously connected to both a primary BT central 404 (e.g., laptop, personal computer, etc.) and another BT central (e.g., a phone). The primary BT central 404 and the secondary BT central 406 are abstracted as a single BT device form the point of view of the peripheral 402.

In the example shown in FIG. 4, the primary BT central 404 holds the token in operation 410 when, for example, the primary BT central is streaming music to the peripheral 402. Both BT centrals 404, 406 can receive transmissions but only primary BT central 404 can transmit. At operation 412, an incoming voice call or other request for interaction occurs at the secondary BT central 406. At this point, a handover can occur from BT central 404 to BT central 406, when the BT central 406 requests the token 408 from BT central 404 in operation 414. Thereafter the BT central 406 becomes the primary BT central. At operation 416 the BT central 406 routes voice for the call to the peripheral 402. The example shown in FIG. 4, as can be appreciated, is not based on mobility, both rather a form of context switching wherein changing chores or tasks leads to handovers (e.g., there is switching based on use case).

Other reasons or impetuses for switching can include notifications or voice commands, for example. In the case of voice commands both the BT central devices 404, 406 can seamlessly listen to the BT peripheral 402 transmissions. So, the BT peripheral 402 can issue voice commands to both the BT centrals 404, 406 on a single BT link, which can be demultiplexed as appropriate by the corresponding BT central 404, 406.

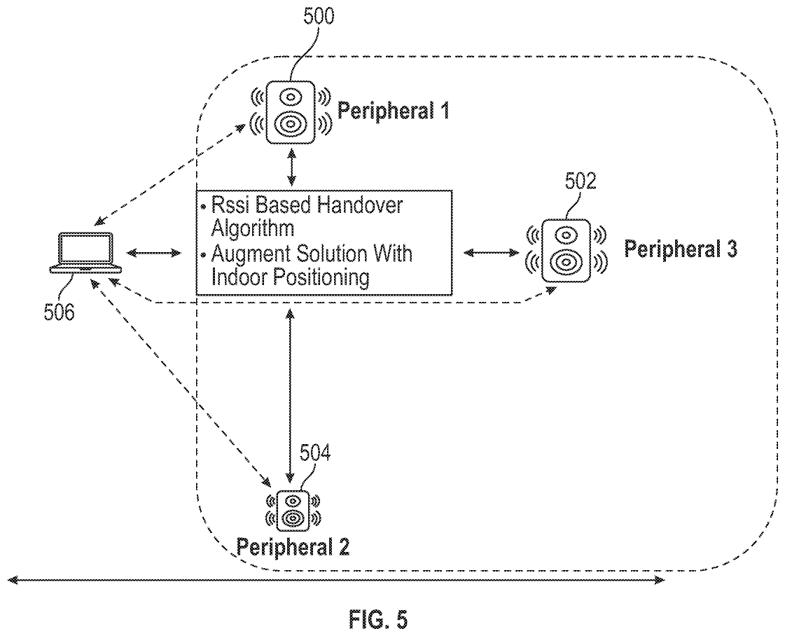

In addition to the above applications, the converse of the Bluetooth central abstraction concept described above can be explored. For example, multiple BT peripherals can present themselves as a single BT peripheral to a roaming BT central device. This is illustrated in FIG. 5. In the scenario illustrated in FIG. 5, the BT peripherals 500, 502, 504 can be abstracted as a single peripheral to the BT central device 506. Alternatively, a RSSI based algorithm running on the BT central 506 can be enhanced with indoor positioning inputs to choose a suitable BT peripheral 500, 502, 504 to switch to.

Aspects according to this disclosure provide seamless BT connectivity and UX for end users with increased Bluetooth coverage by implementing Bluetooth piconet synchronization. Users can experience the benefit of seamless BT audio UX on any of their computing devices even when moving out of the range of their primary device/s. Multipoint Bluetooth features are enabled for all BT peripherals, and single link control is provided for voice commands and notifications from BT peripheral to multiple devices such as a PC, phone etc. Solutions according to aspects of the disclosure require no change in Bluetooth peripheral hardware and software, and without additional power overhead for the peripheral/s. Bluetooth peripherals can be concurrently connected to multiple Bluetooth centrals (for example, five or more BT centrals) seamlessly with no BT peripheral device power impact.

### Improved Audio Experience and Privacy when Connected to Bluetooth Speakers

As mentioned earlier herein, privacy can be a concern when there are multiple possible audio devices or other devices that could stream audio or visual content of the user. Previous efforts to mitigate these concerns focused on manual efforts, wherein if an audio switch over happened between the two different Bluetooth devices, the user was required to manually identify the desired Bluetooth device to be used. This can be time consuming and still result in privacy breach even if for a short time.

To address these and other concerns, methods in accordance with some aspects can provide seamless Bluetooth connectivity experience by notifying the user prior going out of range. In the event of losing connectivity over the previously connected Bluetooth device (due to for example power loss or weak RSSI), an automatic switch over can occur to the headset (or other audio device/BT device) defined in the internal profile based on the priority, proximity and measure of RSSI deviation. The measure of RSSI deviation may be considered as an indicator that the user is wearing that headset/audio device. The user can be notified (e.g., by a user interface push notification, audio signal, voice message, etc.) on the headset ahead of the power loss/disconnection.

When a paired Bluetooth device is in the proximity of a host system, the method according to aspects of the disclosure can confirm if the user is wearing headset using a camera or other recognition mechanism, ensuring that the audio output is routed to intended device.

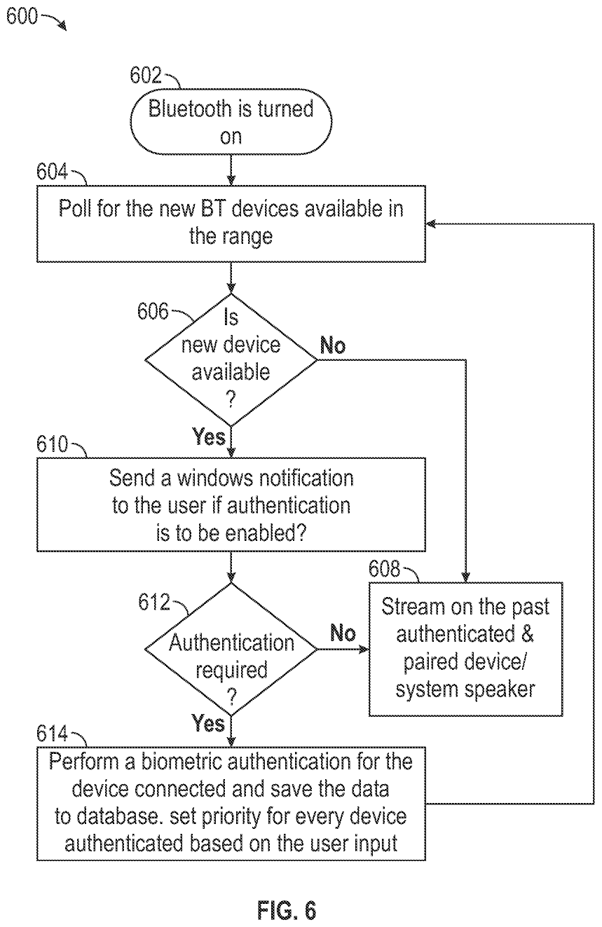

Aspects of the disclosure provide a method 600 similar to that shown in FIG. 6. The method 600 can begin with operation 602 with Bluetooth capability being turned on or enabled in a host system. At operation 604, the host system can poll for new BT devices available within range of the system. If the new device is not available, as determined at operation 606, then audio or other use can continue with the previously-paired device at operation 608. Otherwise, a notification can be sent to the user at operation 610 requesting user input as to whether authentication is to be enabled on the new device.

Upon user's consent to authenticate the device, as determined at decision 612, then authentication is performed at operation 614. Authentication can include biometric authentication. After authentication, a unique ID is defined for the connected device and facial recognition is conducted to identify the respective user and form (or add to) a database with this profile data.

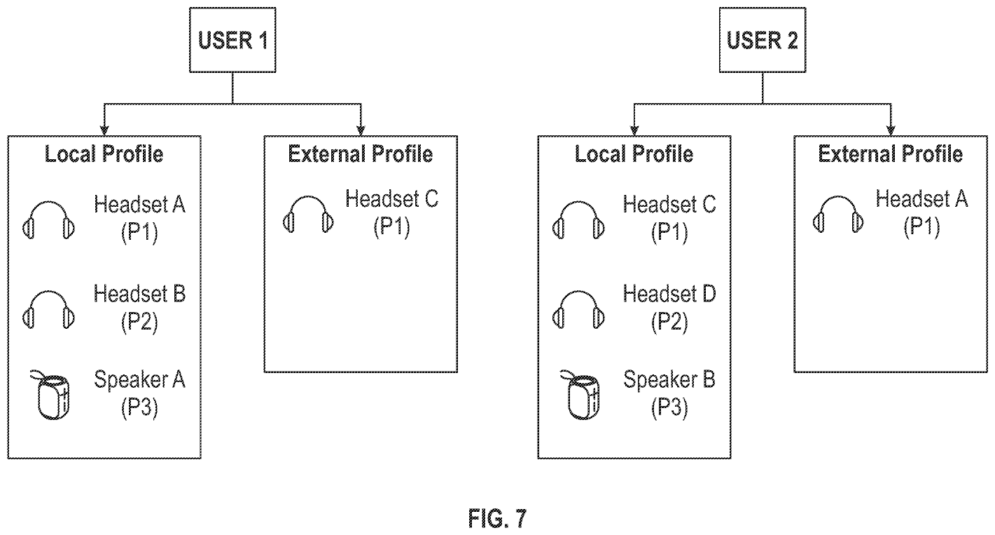

A user can sort the Bluetooth devices into two categories as shown in FIG. 7. FIG. 7 is a visual representation of a database having user profiles according to aspects of the disclosure. A first user can have a group of one or more devices under a local profile and another group of one or more devices under an external profile. A second user can also have a group of one or more devices under a local profile and another group of one or more devices under an external profile. While two users are shown, any number of users can have devices sorted into profiles.

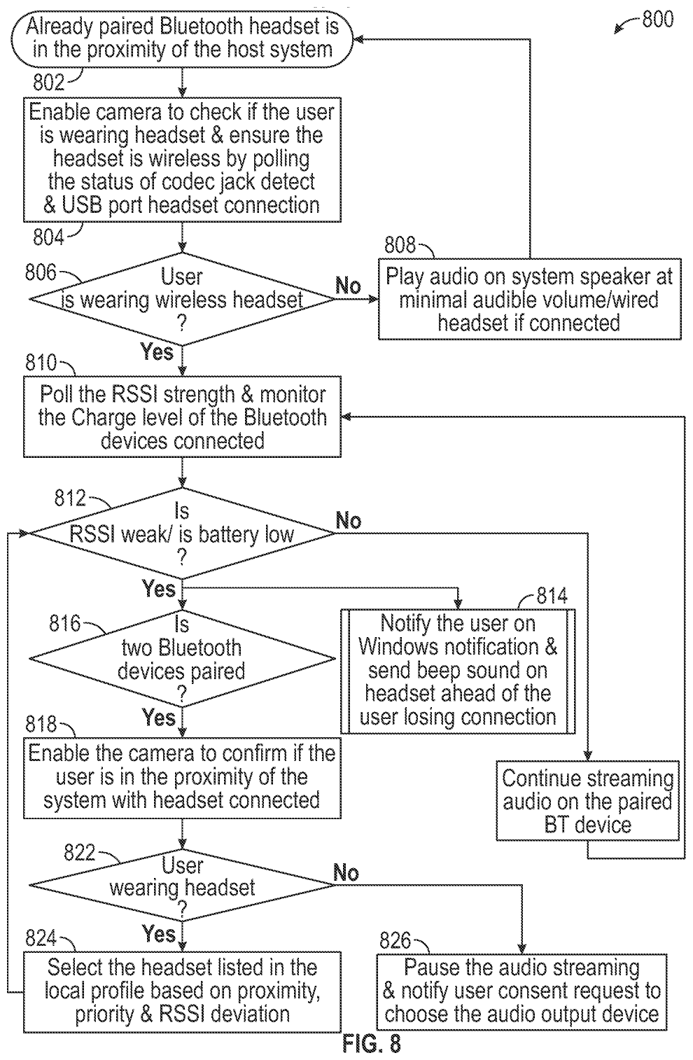

A second method 800 for protecting user privacy in Bluetooth device use is shown in FIG. 8. When the user turns on the Bluetooth on the host system, the host system looks for the new/prior paired devices available in the range in operation 802. In case of new devices perform authentication as mentioned above with respect to FIG. 6.

If the prior paired devices are available, the host system ensures that the user has plugged in (e.g., is wearing) the Bluetooth headset in operation 804. To ensure the user is wearing wireless headset, the host system can poll for status of an audio codec jack or detect USB headphone connectivity status, among other possible checks. If the user is not wearing the headset, as determined at decision block 806, then at operation 808 the audio may be played on a system speaker at minimal volume or audio can be routed to a wired headset if available, among other possible actions.

If the user is wearing wireless headset, then at operation 810 the host can play the audio on the headset and monitor the charge and RSSI strength of the connected headset. At decision 812, the host can determine if there is power loss or weak RSSI. If the host determines there is power loss and/or weak RSSI, in operation 814 the host can notify user (e.g., with a display popup, beep, or voice note on the headset) ahead of losing the connectivity.

If decision 816 determines that two devices paired to the host system, then in operation 818 the camera can be accessed or confirmation can otherwise be made that the user is in proximity of the host system with a headset connected. If the user is wearing a headset as determined in decision 822, then the database table for that user (as shown for example in FIG. 7) can be accessed in operation 824 and the host can route to the paired device based on the proximity of the device to host system and priority assigned on defining/adding that headset to the database. If the second paired device is not present in the database table, then a permission request can be sent to the user asking whether the audio can be played on the headset defined in the external profile a head of losing the connectivity.

If the user is not wearing the headset as determined in decision 822, then in operation 826 audio can be paused and user consent can be requested to choose an audio output device. It will be appreciated that not BT headsets belonging to a user's profile are necessarily always paired to the host device (e.g., PC or laptop). Furthermore, the BT RSSI can be monitored if the headset is in page or inquiry scan modes. Among the headsets defined in the user profile (see e.g., FIG. 7), a BT headset lying idle can be confirmed by noting that there is no active BT connection and no deviation in RSSI.

Solutions according to aspects of the disclosure are not only limits to headsets, but rather methods defined herein can be applied to speakers or any other device that can be paired to a host system.

For example, in another use case a user may have a PC connected to both “headset” and “speaker” with voice and audio enabled on both. The user may get a phone call on his headset (wherein a phone call is assigned first priority within the internal priority database table shown in FIG. 7). A transaction ID can be assigned to the call, and if the user walks away from PC, wearing headset, methods can prevent the call from getting switched to the speaker. This can be done by associating the transaction ID, to only allowing voice over the headset. Other criteria, priorities, and use cases can be defined wherein a user can specify which systems/speakers/headsets should be used for phone calls, video conferences, etc.

Aspects of this disclosure provide enhanced user audio experience while protecting user privacy when connected to Bluetooth headset/speakers. Privacy is enhanced by preventing automatic switchover between the audio devices various home-based or corporate based scenarios. User experience is improved by offering uninterrupted audio streaming.

### Other Systems and Apparatuses

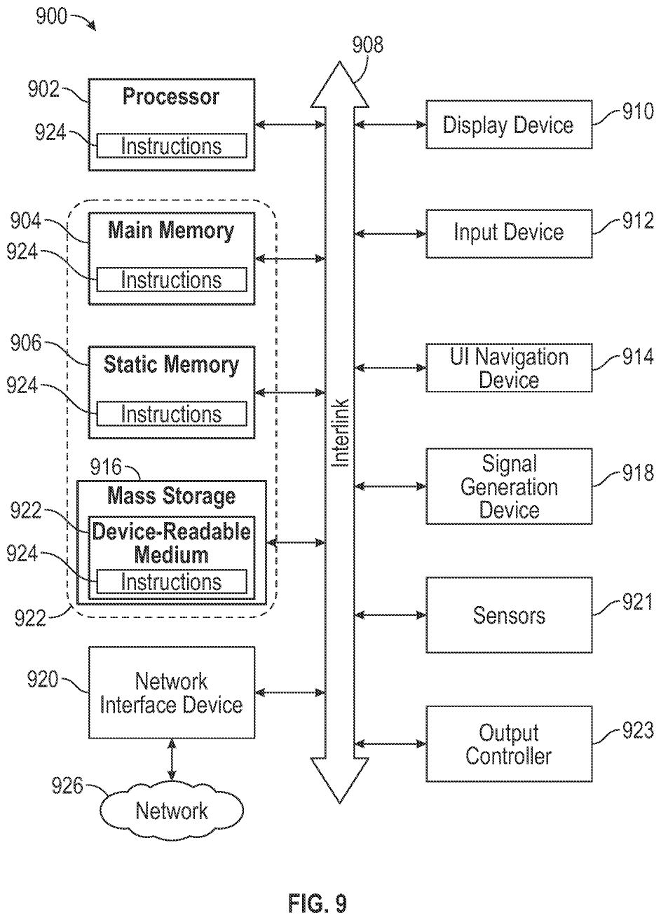

FIG. 9 illustrates a block diagram of a communication device 900 in accordance with some aspects. In alternative aspects, the communication device 900 may operate as a standalone device or may be connected (e.g., networked) to other communication devices. In some aspects, the communication device 900 can use one or more of the techniques and circuits discussed herein, in connection with any of FIG. 1-FIG. 8.

Circuitry (e.g., processing circuitry) is a collection of circuits implemented in tangible entities of the device 900 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 900 follow.

In some aspects, the device 900 may operate as a standalone device or may be connected (e.g., networked) to other devices. In a networked deployment, the communication device 900 may operate in the capacity of a server communication device, a client communication device, or both in server-client network environments. In an example, the communication device 900 may act as a peer communication device in peer-to-peer (P2P) (or other distributed) network environment. The communication device 900 may be a UE, eNB, PC, a tablet PC, a STB, a PDA, a mobile telephone, a smart phone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Communication device (e.g., UE) 900 may include a hardware processor 902 (e.g., a central processing unit (CPU), a graphics processing unit (GPU), a hardware processor core, or any combination thereof), a main memory 904, a static memory 906, and mass storage 916 (e.g., hard drive, tape drive, flash storage, or other block or storage devices), some or all of which may communicate with each other via an interlink (e.g., bus) 908.

The communication device 900 may further include a display unit 910, an alphanumeric input device 912 (e.g., a keyboard), and a user interface (UI) navigation device 914 (e.g., a mouse). In an example, the display unit 910, input device 912 and UI navigation device 914 may be a touch screen display. The communication device 900 may additionally include a signal generation device 918 (e.g., a speaker), a network interface device 920, and one or more sensors 921, such as a global positioning system (GPS) sensor, compass, accelerometer, or other sensor. The communication device 900 may include an output controller 923, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage 916 may include a communication device-readable medium 922, on which is stored one or more sets of data structures or instructions 924 (e.g., software) embodying or utilized by any one or more of the techniques or functions described herein. In some aspects, registers of the processor 902, the main memory 904, the static memory 906, and/or the mass storage 916 may be, or include (completely or at least partially), the device-readable medium 922, on which is stored the one or more sets of data structures or instructions 924, embodying or utilized by any one or more of the techniques or functions described herein. In an example, one or any combination of the hardware processor 902, the main memory 904, the static memory 906, or the mass storage 916 may constitute the device-readable medium 922.

As used herein, the term “device-readable medium” is interchangeable with “computer-readable medium” or “machine-readable medium”. While the communication device-readable medium 922 is illustrated as a single medium, the term “communication device-readable medium” may include a single medium or multiple media (e.g., a centralized or distributed database, and/or associated caches and servers) configured to store the one or more instructions 924.

The term “communication device-readable medium” may include any medium that is capable of storing, encoding, or carrying instructions for execution by the communication device 900 and that cause the communication device 900 to perform any one or more of the techniques of the present disclosure, or that is capable of storing, encoding or carrying data structures used by or associated with such instructions. Non-limiting communication device-readable medium examples may include solid-state memories, and optical and magnetic media. Specific examples of communication device-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), MIMO, or multiple-input single-output (MISO) techniques. In some examples, the network interface device 920 may wirelessly communicate using Multiple User MIMO techniques.

The term “transmission medium” shall be taken to include any intangible medium that is capable of storing, encoding, or carrying instructions for execution by the communication device 900, and includes digital or analog communications signals or other intangible medium to facilitate communication of such software. In this regard, a transmission medium in the context of this disclosure is a device-readable medium.

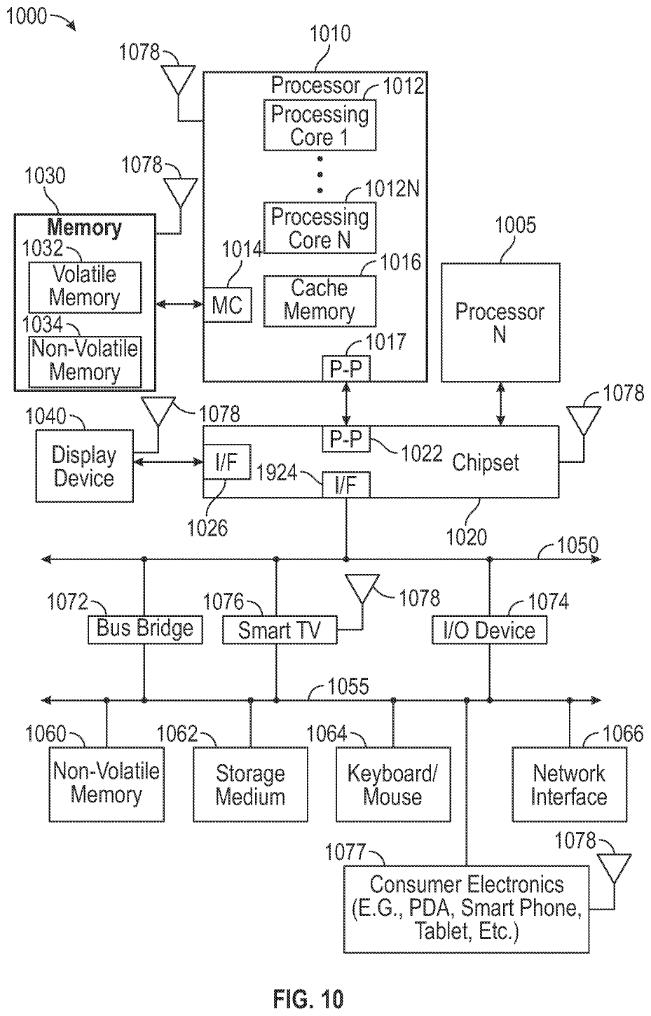

FIG. 10 illustrates a system level diagram, depicting an example of an electronic device (e.g., system) that can include, for example, a transmitter configured to selectively fan out a signal to one of multiple communication channels. FIG. 10 is included to show an example of a higher-level device application for the subject matter discussed above with regards to FIGS. 1-9. In one aspect, system 1000 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance, or any other type of computing device. In some aspects, system 1000 is a system on a chip (SOC) system.

In one aspect, processor 1010 has one or more processor cores 1012, 1012N, where 1012N represents the Nth processor core inside processor 1010 where N is a positive integer. In one aspect, system 1000 includes multiple processors including 1010 and 1005, where processor 1005 has logic similar or identical to the logic of processor 1010. In some aspects, processing core 1012 includes, but is not limited to, pre-fetch logic to fetch instructions, decode logic to decode the instructions, execution logic to execute instructions and the like. In some aspects, processor 1010 has a cache memory 1016 to cache instructions and/or data for system 1000. Cache memory 1016 may be organized into a hierarchal structure including one or more levels of cache memory.

In some aspects, processor 1010 includes a memory controller 1014, which is operable to perform functions that enable the processor 1010 to access and communicate with memory 1030 that includes a volatile memory 1032 and/or a non-volatile memory 1034. In some aspects, processor 1010 is coupled with memory 1030 and chipset 1020. Processor 1010 may also be coupled to a wireless antenna 1078 to communicate with any device configured to transmit and/or receive wireless signals. In one aspect, an interface for wireless antenna 1078 operates in accordance with, but is not limited to, the IEEE 802.11 standard and its related family, Home Plug AV (HPAV), Ultra Wide Band (UWB), Bluetooth, WiMax, or any form of wireless communication protocol.

In some aspects, volatile memory 1032 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Non-volatile memory 1034 includes, but is not limited to, flash memory, phase change memory (PCM), read-only memory (ROM), electrically erasable programmable read-only memory (EEPROM), or any other type of non-volatile memory device.

Memory 1030 stores information and instructions to be executed by processor 1010. In one aspect, memory 1030 may also store temporary variables or other intermediate information while processor 1010 is executing instructions. In the illustrated aspect, chipset 1020 connects with processor 1010 via Point-to-Point (PtP or P-P) interfaces 1017 and 1022. Chipset 1020 enables processor 1010 to connect to other elements in system 1000. In some aspects of the example system, interfaces 1017 and 1022 operate in accordance with a PtP communication protocol such as the Intel® QuickPath Interconnect (QPI) or the like. In other aspects, a different interconnect may be used.

In some aspects, chipset 1020 is operable to communicate with processor 1010, 1005, display device 1040, and other devices, including a bus bridge 1072, a smart TV 1076, I/O devices 1074, nonvolatile memory 1060, a storage medium (such as one or more mass storage devices) 922, a network interface 1066, and various forms of consumer electronics 1077 (such as a PDA, smart phone, tablet etc.), etc. In one aspect, chipset 1020 couples with these devices through an interface 1924. Chipset 1020 may also be coupled to a wireless antenna 1078 to communicate with any device configured to transmit and/or receive wireless signals.

Chipset 1020 connects to display device 1040 via interface 1026. Display device 1040 may be, for example, a liquid crystal display (LCD), a plasma display, cathode ray tube (CRT) display, or any other form of visual display device. In some aspects of the example system, processor 1010 and chipset 1020 are merged into a single SOC. In addition, chipset 1020 connects to one or more buses 1050 and 1055 that interconnect various system elements, such as I/O devices 1074, nonvolatile memory 1060, storage medium 922, and network interface 1066. Buses 1050 and 1055 may be interconnected together via a bus bridge 1072.

In one aspect, storage medium 922 includes, but is not limited to, a solid-state drive, a hard disk drive, a universal serial bus flash memory drive, or any other form of computer data storage medium. In one aspect, network interface 1066 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one aspect, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 10 are depicted as separate blocks within the system 1000, the functions performed by some of these blocks may be integrated within a single semiconductor circuit or may be implemented using two or more separate integrated circuits. For example, although cache memory 1016 is depicted as a separate block within processor 1010, cache memory 1016 (or selected aspects of 1016) can be incorporated into processor core 1012.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “an example aspect”, “some aspects”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a sensor device, an Internet of Things (IoT) device, a wearable device, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may, for example, be used in conjunction with devices and/or networks operating in accordance with existing IEEE 802.11 standards (including IEEE 802.11-2016 (IEEE 802.11-2016, IEEE Standard for Information technology—Telecommunications and information exchange between systems Local and metropolitan area networks—Specific requirements Part 11: Wireless LAN Medium Access Control (MAC) and Physical Layer (PHY) Specifications, Dec. 7, 2016); IEEE 802.11ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHZ)) and/or future versions and/or derivatives thereof, devices and/or networks operating in accordance with existing WiFi Alliance (WFA) Peer-to-Peer (P2P) specifications (including WiFi P2P technical specification, version 1.5, Aug. 4, 2015) and/or future versions and/or derivatives thereof, devices and/or networks operating in accordance with existing Wireless-Gigabit-Alliance (WGA) specifications (including Wireless Gigabit Alliance, Inc WiGig MAC and PHY Specification Version 1.1, April 2011, Final specification) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Spatial Divisional Multiple Access (SDMA), FDM Time-Division Multiplexing (TDM), Time-Division Multiple Access (TDMA), Multi-User MIMO (MU-MIMO), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that is integrated with a computer, or a peripheral that is attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting and/or the action of receiving. In one example, the phrase “communicating a signal” may refer to the action of transmitting the signal by a first device and may not necessarily include the action of receiving the signal by a second device. In another example, the phrase “communicating a signal” may refer to the action of receiving the signal by a first device and may not necessarily include the action of transmitting the signal by a second device.

Some demonstrative aspects may be used in conjunction with a wireless communication network communicating over a frequency band above 45 Gigahertz (GHz), e.g., 60 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a frequency band above 45 GHz, a frequency band below 20 GHz, e.g., a Sub 1 GHz (S1G) band, a 2.4 GHz band, a 5 GHz band, a WLAN frequency band, a WPAN frequency band, a frequency band according to the WGA specification, and the like.

As used herein, the term “circuitry” may, for example, refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, circuitry may include logic, at least partially operable in hardware. In some aspects, the circuitry may be implemented as part of and/or in the form of a radio virtual machine (RVM), for example, as part of a Radio processor (RP) configured to execute code to configured one or more operations and/or functionalities of one or more radio components.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “antenna” or “antenna array”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

### Additional Notes and Aspects

Example 1 is a control device comprising an interface configured to wirelessly receive and transmit a communication signal; and processing circuitry coupled to the interface, the processing circuitry configured to: exchange information with at least one other device to determine which device should communicate to a peripheral device; pass a token to the at least one other device in response to detecting the at least one other device should communicate to the peripheral device; and refrain from further transmissions to the peripheral device upon passing the token.

In Example 2, the subject matter of Example 1 can optionally include wherein the at least one other device comprises a second control device, and wherein the processing circuitry is configured to exchange synchronization signals to synchronize to at least one other device.

In Example 3, the subject matter of Example 2 can optionally include wherein the information indicates signal strength to the peripheral device.

In Example 4, the subject matter of any of Examples 1-3 can optionally include wherein the processing circuitry is configured to continue receiving signals form the peripheral device subsequent to passing the token.

In Example 5, the subject matter of Example 2 can optionally include wherein determining which device should communicate to the peripheral device is based on a signal strength of communications with the peripheral device.

In Example 6, the subject matter of Example 2 can optionally include wherein determining which device should communicate to the peripheral device is based on a usage mode of the peripheral device.

In Example 7, the subject matter of Example 2 can optionally include wherein both the control device and the at least one other device concurrently decode communications from the peripheral device, and wherein determining which device should communicate to the peripheral device is based an interpreted command from the peripheral device.

In Example 8, the subject matter of any of Examples 1-7 can optionally include wherein the communication signal is in accordance with a Bluetooth standard.

Example 9 is a control device comprising communication circuitry configured to communicate to at least two peripheral devices; and processing circuitry coupled to the communication circuitry and configured to: control communications with a first device of the at least two peripheral devices; and upon detecting that the first device has become disconnected, request user authorization to connect to a second of the at least two peripheral devices.

In Example 10, the subject matter of Example 9 can optionally include a memory and wherein authorization is stored to memory each time a new peripheral device is connected to the control device.

In Example 11, the subject matter of Example 10 can optionally include wherein the processing circuitry is configured to store user profiles for a plurality of users.

In Example 12, the subject matter of Example 10 can optionally include wherein a user is prompted to set priority levels for the at least two peripheral devices.

In Example 13, the subject matter of any of Examples 9-12 can optionally include wherein the processing circuitry is configured to an authorization request to a user interface.

In Example 14, the subject matter of any of Examples 9-13 can optionally include wherein the processing circuitry is configured to perform a biometric check of a user as a part of requesting user authentication.

Example 15 is a non-transitory computer-readable medium including instructions that, when executed on processing circuitry, cause the processing circuitry to perform operations comprising any of Examples 1-14.

Example 16 is a system comprising means for performing any of Examples 1-14.

The above detailed description includes references to the accompanying drawings, which form a part of the detailed description. The drawings show, by way of illustration, specific aspects in which the invention can be practiced. These aspects are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description, with each claim standing on its own as a separate aspect, and it is contemplated that such aspects can be combined with each other in various combinations or permutations. The scope of the invention should be determined with reference to the appended claims, along with the full scope of equivalents to which such claims are legally entitled.

We claim:

1. A control device comprising:
an interface configured to wirelessly receive and transmit a communication signal; and
processing circuitry coupled to the interface, the processing circuitry configured to:
exchange information with at least one other device to determine which device should communicate to a peripheral device;
pass a token to the at least one other device in response to detecting the at least one other device should communicate to the peripheral device; and
refrain from further transmissions to the peripheral device upon passing the token.

2. The control device of claim 1, wherein the at least one other device comprises a second control device, and wherein the processing circuitry is configured to exchange synchronization signals to synchronize to at least one other device.

3. The control device of claim 2, wherein the information indicates signal strength to the peripheral device.

4. The control device of claim 1, wherein the processing circuitry is configured to continue receiving signals form the peripheral device subsequent to passing the token.

5. The control device of claim 2, wherein determining which device should communicate to the peripheral device is based on a signal strength of communications with the peripheral device.

6. The control device of claim 2, wherein determining which device should communicate to the peripheral device is based on a usage mode of the peripheral device.

7. The control device of claim 2, wherein both the control device and the at least one other device concurrently decode communications from the peripheral device, and wherein determining which device should communicate to the peripheral device is based on an interpreted command from the peripheral device.

8. The control device of claim 1, wherein the communication signal is in accordance with a Bluetooth standard.

9. A control device comprising:
communication circuitry configured to communicate to at least two peripheral devices, and
processing circuitry coupled to the communication circuitry and configured to:
control communications with a first device of the at least two peripheral devices; and
upon detecting that the first device has become disconnected, request user authorization to connect to a second of the at least two peripheral devices.

10. The control device of claim 9, further comprising a memory and wherein authorization is stored to memory each time a new peripheral device is connected to the control device.

11. The control device of claim 10, wherein the processing circuitry is configured to store user profiles for a plurality of users.

12. The control device of claim 10, wherein a user is prompted to set priority levels for the at least two peripheral devices.

13. The control device of claim 9, wherein the processing circuitry is configured to an authorization request to a user interface.

14. The control device of claim 9, wherein the processing circuitry is configured to perform a biometric check of a user as a part of requesting user authentication.

15. A non-transitory computer-readable medium including instructions that, when executed on processing circuitry, cause the processing circuitry to perform operations comprising:
communicating to at least two peripheral devices;
controlling communications with a first device of the at least two peripheral devices; and
upon detecting that the first device has become disconnected, requesting user authorization to connect to a second of the at least two peripheral devices.

16. The non-transitory computer-readable medium of claim 15, wherein authorization is stored to memory each time a new peripheral device is connected to the control device.

17. The non-transitory computer-readable medium of claim 16, wherein the operations further comprise storing user profiles for a plurality of users.

18. The non-transitory computer-readable medium of claim 16, wherein a user is prompted to set priority levels for the at least two peripheral devices.

19. The non-transitory computer-readable medium of claim 15, wherein the operations further comprise providing an authorization request to a user interface.

20. The non-transitory computer-readable medium of claim 19, wherein the operations further comprise performing a biometric check of a user as a part of requesting user authentication.
